(19) United States
(12) Patent Application Publication
(10) Pub. No.: US 2025/0298646 A1
(43) Pub. Date: Sep. 25, 2025

(54) DEVICE SHARING METHOD, ELECTRONIC DEVICE, AND COMPUTER-READABLE STORAGE MEDIUM

(71) Applicant: GUANGZHOU SHIZHEN INFORMATION TECHNOLOGY CO., LTD., Guangzhou (CN)

(72) Inventor: Sheng HUANG, Guangzhou (CN)

(73) Assignee: GUANGZHOU SHIZHEN INFORMATION TECHNOLOGY CO., LTD., Guangzhou (CN)

(21) Appl. No.: 19/230,642

(22) Filed: Jun. 6, 2025

Related U.S. Application Data
(63) Continuation of application No. PCT/CN2023/128526, filed on Oct. 31, 2023.

(30) Foreign Application Priority Data
Dec. 6, 2022 (CN) 202211558376.5

(51) Int. Cl. G06F 9/455; G06F 3/14

(52) U.S. Cl. CPC G06F 9/455; G06F 3/1454

(57) ABSTRACT

A device sharing method, an electronic device, and a computer-readable storage medium are provided. The device sharing method includes: providing a virtual drive, and sending a data collection command to a screen sharing receiver; receiving functional data sent by the screen sharing receiver, wherein, in response to the data collection command, the screen sharing receiver controls a peripheral device connected to the screen sharing receiver to perform data collection to obtain the functional data; and based on the functional data, utilizing the virtual drive to emulate a functional device corresponding to the peripheral device.

### CROSS-REFERENCE TO RELATED APPLICATION

The present application is a continuation of International Application No. PCT/CN2023/128526, filed on Oct. 31, 2023, which claims the benefit of priority to Chinese Patent Application No. 202211558376.5, filed on Dec. 6, 2022. The entire contents of the above-identified applications are expressly incorporated herein by reference.

### TECHNICAL FIELD

The present disclosure relates to the technical field of screen sharing, and specifically relates to a device sharing method, an electronic device, and a computer-readable storage medium.

### BACKGROUND

With the emergence and diversification of scenarios such as business meetings, home entertainment, and competitive gaming, screen sharing (casting) as a display technology for presenting display content of the opposite end has begun to be widely used in the above scenarios. Its feature is to collect the screen content of the screen sharing initiator and use wireless or wired transmission technology to transmit it to the screen sharing receiver for synchronous display.

During the screen sharing process, in addition to sharing screen data, sometimes it is also necessary to call peripheral devices, such as cameras and microphones. For the screen sharing initiator (such as a PC, mobile phone, notebook, etc.), generally no peripheral device is connected, or the connected peripheral device has limited performance; while for the screen sharing receiver (such as a conference panel, screen sharing box, etc.), its peripheral device performance is better. The screen sharing process is generally controlled by the screen sharing initiator. When it is necessary to use a peripheral device, the user of the screen sharing receiver needs to manually enable the relevant peripheral device, and the screen sharing initiator cannot perform corresponding control.

### SUMMARY

The embodiments of the present disclosure provide a device sharing method, an electronic device, and a computer-readable storage medium, so that the screen sharing initiator can call the peripheral device of the screen sharing receiver to realize sharing of the peripheral device of the screen sharing receiver.

The present disclosure provides a device sharing method, applied to a screen sharing initiator. The method includes: providing a virtual drive, and sending a data collection command to the screen sharing receiver; receiving functional data sent by the screen sharing receiver, where, in response to the data collection command, the screen sharing receiver controls a peripheral device connected to the screen sharing receiver to perform data collection to obtain the functional data; and based on the functional data, utilizing the virtual drive to emulate a functional device corresponding to the peripheral device.

The present disclosure also provides an electronic device, which includes a processor and a memory, where the memory is used to store program data, and the processor is used to execute the program data to implement the above method.

The present disclosure also provides a computer-readable storage medium, where the computer-readable storage medium stores program data, and the program data, when executed by a processor, is used to implement the above method.

The device sharing method provided by the embodiments of the present disclosure includes: providing a virtual drive, and sending a data collection command to the screen sharing receiver; receiving functional data sent by the screen sharing receiver, where, in response to the data collection command, the screen sharing receiver controls a peripheral device connected to the screen sharing receiver to perform data collection to obtain the functional data; and based on the functional data, utilizing the virtual drive to emulate a functional device corresponding to the peripheral device. Through the above method, the virtual drive provided by the screen sharing initiator is utilized to emulate the peripheral device of the screen sharing receiver. First, sharing of the peripheral device of the screen sharing receiver is realized; second, only the screen sharing initiator and the screen sharing receiver are needed, and no other intermediate device is required for data processing; third, the virtual drive can be provided and destroyed in real time as needed, and is suitable for various different peripheral devices, with good scalability; and fourth, the virtual drive is utilized to emulate the peripheral device, and compared with hardware data transmission encoding and decoding, the software implementation can support more data formats, reduce data distortion, and provide better presentation effects.

### BRIEF DESCRIPTION OF DRAWINGS

In order to illustrate the technical solutions in the embodiments of the present disclosure, the drawings required for the description of the embodiments will be briefly introduced below. It is obvious that the drawings described below are only some embodiments of the present disclosure. For those skilled in the art, other drawings can also be obtained based on these drawings without creative efforts.

FIG. 1 is a flow diagram of a first embodiment of the device sharing method provided by the present disclosure;

FIG. 2 is an interaction diagram of a first embodiment of the device sharing method provided by the present disclosure;

FIG. 3 is a flow diagram of a second embodiment of the device sharing method provided by the present disclosure;

FIG. 4 is a flow diagram of a third embodiment of the device sharing method provided by the present disclosure;

FIG. 5 is a schematic diagram of the interface of the screen sharing application provided by the present disclosure;

FIG. 6 is a flow diagram of a fourth embodiment of the device sharing method provided by the present disclosure;

FIG. 7 is a structural diagram of an embodiment of an electronic device provided by the present disclosure; and

FIG. 8 is a structural diagram of an embodiment of a computer-readable storage medium provided by the present disclosure.

### DETAILED DESCRIPTION

The embodiments of the present disclosure will be described below in conjunction with the accompanying drawings in the embodiments of the present disclosure. Obviously, the described embodiments are only a part of the embodiments of the present disclosure, and not all embodiments. Based on the embodiments in the present disclosure, all other embodiments obtained by those skilled in the art without creative efforts shall fall within the protection scope of the present disclosure.

The embodiment of the present disclosure provides a device sharing method, mainly applied in the process where a screen sharing initiator shares a screen to a screen sharing receiver, and the screen sharing initiator calls a peripheral device of the screen sharing receiver, or the screen sharing receiver calls a peripheral device of the screen sharing initiator, so as to realize sharing of peripheral devices. In a specific application scenario, the screen sharing initiator calls the peripheral device of the screen sharing receiver to realize sharing of the peripheral device of the screen sharing receiver. For example, in the process of screen sharing between a Personal Computer (PC) and a conference terminal, the PC calls the peripheral device of the conference terminal, so that the conference terminal realizes sharing of the peripheral device.

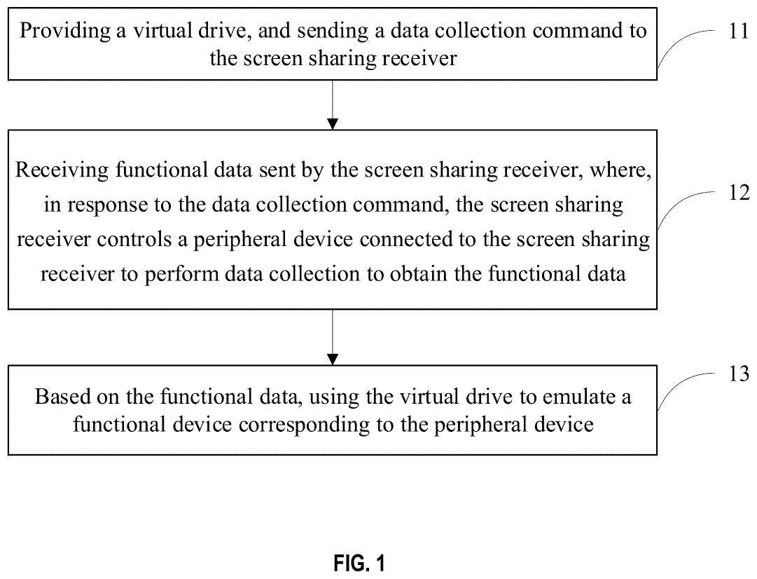

Referring to FIG. 1, FIG. 1 is a flow diagram of a first embodiment of the device sharing method provided by the present disclosure, which is applied to a screen sharing initiator. The method includes the following.

Operation 11: providing a virtual drive, and sending a data collection command to the screen sharing receiver.

The virtual drive refers to an area in the Random-Access Memory (RAM) region of a personal computer that emulates a physical disk of the computer. The virtual drive is not a real drive, such as a Compact Disc Read-Only Memory (CD-ROM) or floppy drive, but a drive emulated by software with the same or similar functions as a real drive, except that the files used on the drive are virtual files, not actual CDs or floppy disks.

The virtual drive here can be provided as different types of drives according to different peripheral devices. For example, if it is necessary to share the camera of the screen sharing receiver, a virtual camera driver can be provided; and if it is necessary to share the microphone of the screen sharing receiver, a virtual microphone driver can be provided.

There are many ways to provide a virtual drive, such as creating or loading a virtual drive, as described in detail below. In some embodiments, the function of providing a virtual drive can be integrated into the screen sharing application.

In some embodiments, the screen sharing application integrates multiple virtual peripheral drivers, such as a virtual camera driver, a virtual microphone driver, etc. In operation 11, only the required driver needs to be loaded.

Taking the Windows system as an example, to provide a virtual drive, the API function DefineDosDevice is used. This function can associate a specified directory with a specified drive, displaying it as a drive.

The C#definition of this API function is:
[DllImport(“kernel32.dll”)]
static extern bool DefineDosDevice (uint dwFlags, string IpDeviceName, string lpTargetPath);

Inside Windows, this is defined as device names and symbolic links. Device names are divided into NT internal device names and MSDOS device names. NT device names are in formats such as “\Device\CDRom0” and “\Device\Serial0”. MSDOS device names are symbolic links to NT device names for convenient access. Each MSDOS device name can point to at most one internal NT device, but multiple MSDOS device names can point to a single device.

Further, in operation 11, sending the data collection command to the screen sharing receiver can be performed based on the connection method between the screen sharing initiator and the screen sharing receiver, such as wired or wireless methods. Wireless methods can include WIFI, Bluetooth, 4G, 5G, etc. The data collection command is used to control the screen sharing receiver to control the connected peripheral device to perform corresponding data collection.

It can be understood that in operation 11, the order of providing the virtual drive and sending the data collection command is not limited. For example, the virtual drive can be provided first and then the data collection command sent, or the data collection command can be sent first and then the virtual drive provided. In some embodiments, the virtual drive can be provided in advance, and in operation 11, only the corresponding virtual drive needs to be loaded.

Operation 12: receiving functional data sent by the screen sharing receiver, where in response to the data collection command, the screen sharing receiver controls a peripheral device connected to the screen sharing receiver to perform data collection to obtain the functional data.

The functional data corresponds to the function of the corresponding peripheral device. For example, if the peripheral device is a camera, the collected functional data is video data or image data; and if the peripheral device is a microphone, the collected functional data is audio data. The peripheral device can also be an input device such as a keyboard, mouse, stylus, or a game controller for obtaining operation input.

In some embodiments, the screen sharing receiver establishes a connection with at least one peripheral device in advance, which can be connected by wired or wireless means. Taking a camera as an example, the camera can be connected to the screen sharing receiver via USB. When no data collection command is received, the camera is in an off or sleep state. After receiving the data collection command, the screen sharing receiver controls the camera to start capturing.

Operation 13: based on the functional data, using the virtual drive to emulate a functional device corresponding to the peripheral device.

Still taking the camera as an example, after creating or loading the virtual drive in operation 11, a virtual camera is provided using the virtual drive. The virtual hardware information of the virtual camera is provided to the operating system, so that the operating system recognizes the virtual camera as a physical device and establishes communication. The virtual camera receives operation commands sent by the operating system, and based on the operation commands, controls the virtual camera, such as controlling the virtual camera to capture images. The virtual camera then provides the obtained functional data as collected data to the operating system for display.

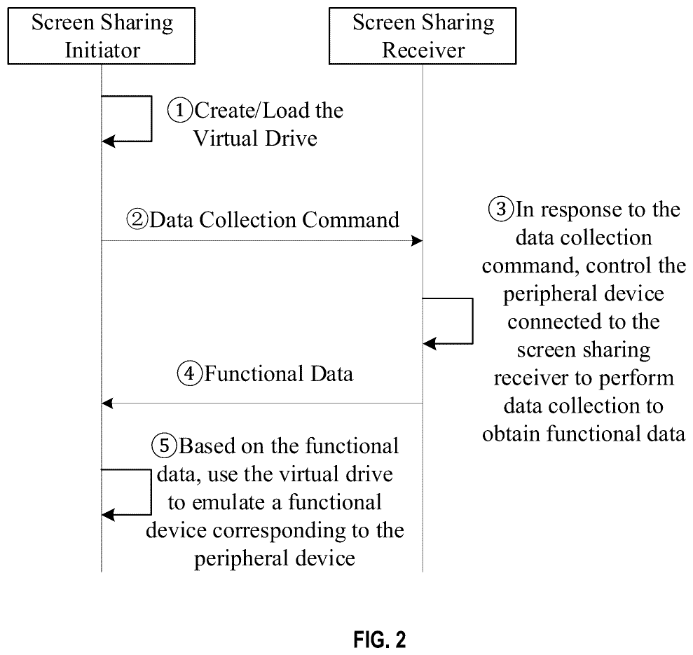

Below, in conjunction with FIG. 2, which is an interaction diagram of the first embodiment of the device sharing method provided by the present disclosure, the above embodiment is described:
1. The screen sharing initiator creates/loads the virtual drive;
2. The screen sharing initiator sends a data collection command to the screen sharing receiver, and the screen sharing receiver receives the data collection command sent by the screen sharing initiator;
3. In response to the data collection command, the screen sharing receiver controls the peripheral device connected to the screen sharing receiver to perform data collection to obtain functional data;
4. The screen sharing receiver sends the functional data to the screen sharing initiator, and the screen sharing initiator receives the functional data sent by the screen sharing receiver; and
5. The screen sharing initiator, based on the functional data, uses the virtual drive to emulate a functional device corresponding to the peripheral device.

In a camera application scenario, taking the emulation of a camera as an example: the screen sharing initiator creates/loads the virtual drive and provides a virtual camera. The operating system obtains the device information of the virtual camera and establishes a communication connection. The screen sharing initiator sends a data collection command to the screen sharing receiver. The screen sharing receiver receives the data collection command sent by the screen sharing initiator. In response to the data collection command, the screen sharing receiver controls the camera connected to the screen sharing receiver to capture images, thereby obtaining functional data (e.g., video data stream). The screen sharing receiver sends the video data stream to the screen sharing initiator. The screen sharing initiator receives the video data stream sent by the screen sharing receiver. The virtual camera emulates the function of the camera to capture images, and sends the obtained video data stream as collected data to the operating system, which plays the video data stream as data captured by the virtual camera.

Compared with the related art, the device sharing method provided by this embodiment includes: providing a virtual drive, and sending a data collection command to the screen sharing receiver; receiving functional data sent by the screen sharing receiver, where, in response to the data collection command, the screen sharing receiver controls a peripheral device connected to the screen sharing receiver to perform data collection to obtain the functional data; and based on the functional data, using the virtual drive to emulate a functional device corresponding to the peripheral device. Through the above method, the virtual drive provided by the screen sharing initiator is used to emulate the peripheral device of the screen sharing receiver. First, sharing of the peripheral device of the screen sharing receiver is realized; second, only the screen sharing initiator and the screen sharing receiver are needed, and no other intermediate device is required for data processing; third, the virtual drive can be provided and destroyed in real time as needed, and is suitable for various different peripheral devices, with good scalability; and fourth, the virtual drive is used to emulate the peripheral device, and compared with hardware data transmission encoding and decoding, the software implementation can support more data formats, reduce data distortion, and provide better presentation effects.

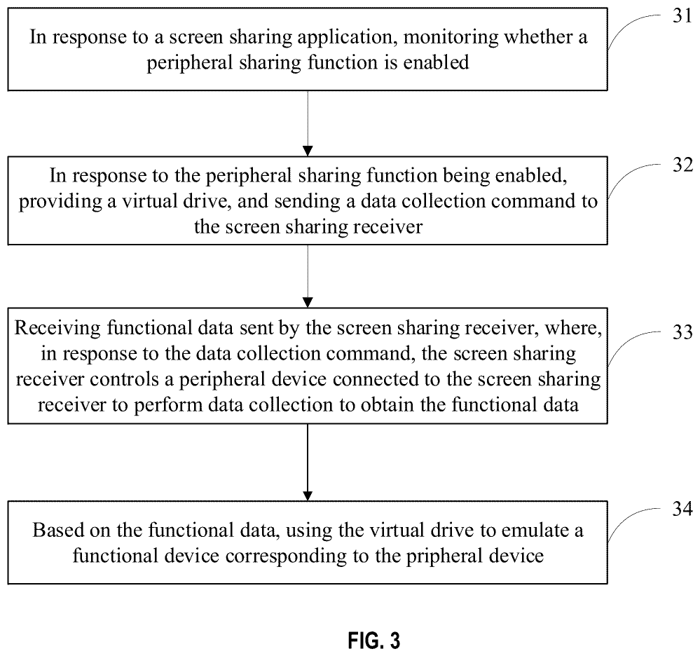

Referring to FIG. 3, FIG. 3 is a flow diagram of a second embodiment of the device sharing method provided by the present disclosure, which is applied to a screen sharing initiator. The method includes the following:

Operation 31: in response to starting a screen sharing application, monitoring whether a peripheral sharing function is enabled.

Operation 32: in response to the peripheral sharing function being enabled, providing a virtual drive, and sending a data collection command to the screen sharing receiver.

It can be understood that in some embodiments, the peripheral sharing function can be enabled or disabled in the screen sharing application. The screen sharing application is an application implemented in an electronic device for performing screen sharing operations, such as Screen Sharing Assistant, AirPinPcSender, Screen Casting Genie, Ali TV Assistant, etc., and can also be applied to video conferencing applications such as Tencent Meeting, Zoom, Xiao Yu Yilian, etc.

In some embodiments, the screen sharing application integrates a virtual drive. When it is detected that the peripheral sharing function is enabled, the corresponding virtual drive is loaded; or, the screen sharing application does not provide a virtual drive initially, and when it is detected that the peripheral sharing function is enabled, the corresponding virtual drive is provided.

Operation 33: receiving functional data sent by the screen sharing receiver, where, in response to the data collection command, the screen sharing receiver controls a peripheral device connected to the screen sharing receiver to perform data collection to obtain the functional data.

Operation 34: based on the functional data, using the virtual drive to emulate a functional device corresponding to the peripheral device.

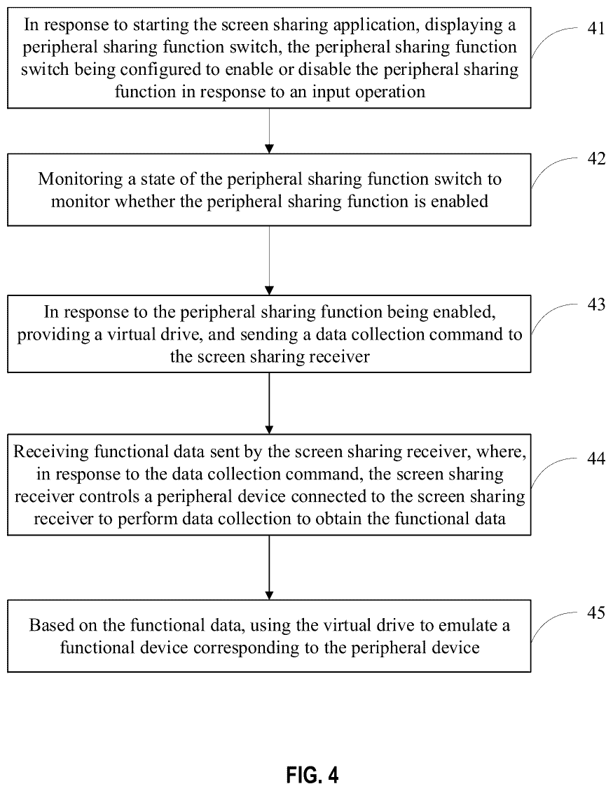

Referring to FIG. 4, FIG. 4 is a flow diagram of a third embodiment of the device sharing method provided by the present disclosure, which is applied to a screen sharing initiator. The method includes the following.

Operation 41: in response to starting the screen sharing application, displaying a peripheral sharing function switch, the peripheral sharing function switch being configured to enable or disable the peripheral sharing function in response to an input operation.

Operation 42: monitoring a state of the peripheral sharing function switch to monitor whether the peripheral sharing function is enabled.

In some embodiments, operation 42 can include: in response to starting the screen sharing application, displaying an application interface of the screen sharing application, the application interface including a peripheral sharing function button; and in response to confirmation of the peripheral sharing function button, displaying at least one peripheral type and a switch indicator corresponding to each peripheral type, the switch indicator being configured to enable or disable a peripheral device corresponding to a respective peripheral type in response to the input operation.

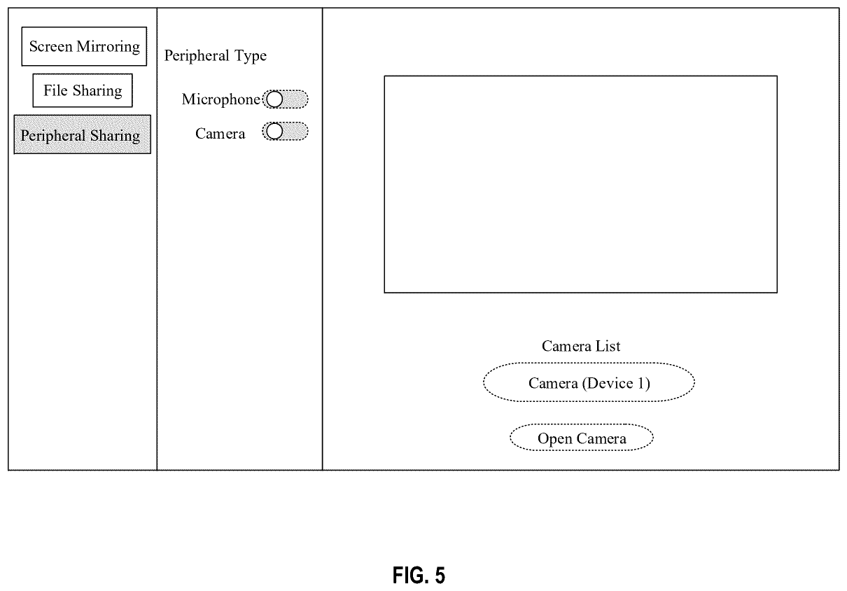

As shown in FIG. 5, which is a schematic diagram of the interface of the screen sharing application provided by the present disclosure, the application display interface can include multiple function buttons, such as “Screen Mirroring,” “File Sharing,” “Peripheral Sharing,” etc. When the user clicks the “Peripheral Sharing” button, the peripheral sharing function switch is triggered to be enabled.

In some embodiments, corresponding to the left area of FIG. 5, when the user clicks the “Peripheral Sharing” button, indicating that the peripheral sharing function is enabled, the next operation 43 can be performed, creating/loading the virtual drive, and sending a data collection command to the screen sharing receiver.

In another embodiment, corresponding to the left and middle areas of FIG. 5, when the user clicks the “Peripheral Sharing” button, the corresponding peripheral types are displayed, such as “Microphone,” “Camera,” each peripheral type corresponding to a switch indicator. The switch indicator is off by default. When the user clicks the switch indicator corresponding to a peripheral type, indicating that the corresponding peripheral needs to be shared, the next operation 43 can be performed, creating/loading the virtual drive, and sending a data collection command to the screen sharing receiver.

The peripheral types can be obtained through interaction with the screen sharing receiver. For example, when the screen sharing initiator connects to the screen sharing receiver, the screen sharing receiver obtains the device information of all connected peripheral devices and sends it to the screen sharing initiator. During the connection operation, the screen sharing receiver monitors all connection interfaces, and when a new peripheral device is connected, sends the corresponding device information to the screen sharing initiator.

In some embodiments, corresponding to the right area of FIG. 5, in response to the switch indicator corresponding to a target peripheral type being enabled, a corresponding peripheral device list and a data display interface corresponding to a selected peripheral device are displayed. For example, when the user clicks the switch indicator to the right of “Camera,” the camera list is displayed in the right area. The user can select the desired camera from the camera list, and then click “Open Camera,” and the display area above the button will display the image captured by the corresponding camera.

Operation 43: in response to the peripheral sharing function being enabled, providing a virtual drive, and sending a data collection command to the screen sharing receiver.

Operation 44: receiving functional data sent by the screen sharing receiver, where, in response to the data collection command, the screen sharing receiver controls a peripheral device connected to the screen sharing receiver to perform data collection to obtain the functional data.

In some embodiments, before operation 41, the screen sharing initiator and the screen sharing receiver establish a data connection in advance, for example by wired or wireless means. When the screen sharing initiator sends a data collection command to the screen sharing receiver, or the screen sharing receiver sends functional data to the screen sharing initiator, the pre-established data transmission channel can still be used.

In a specific application scenario, after the screen sharing receiver receives the data collection command, the screen displays “XX device wants to share YY peripheral, do you agree?” After the screen sharing receiver receives the confirmation operation, it controls the data collection of the corresponding YY peripheral and sends it to the screen sharing initiator.

Further, to ensure the real-time nature of the data, the above functional data is sent to the screen sharing initiator in real time.

Operation 45: based on the functional data, using the virtual drive to emulate a functional device corresponding to the peripheral device.

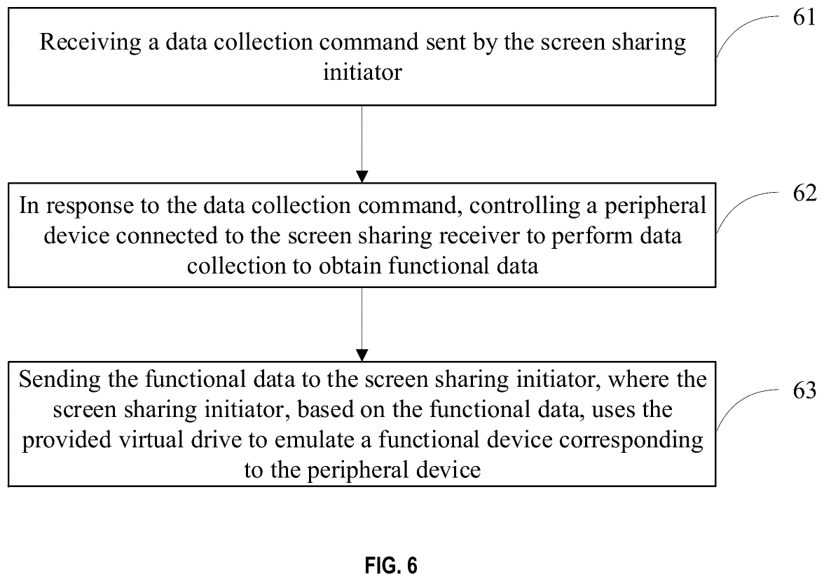

Referring to FIG. 6, FIG. 6 is a flow diagram of a fourth embodiment of the device sharing method provided by the present disclosure, which is applied to a screen sharing receiver. The method includes the following:

Operation 61: receiving a data collection command sent by the screen sharing initiator.

Operation 62: in response to the data collection command, controlling a peripheral device connected to the screen sharing receiver to perform data collection to obtain functional data.

The functional data corresponds to the function of the corresponding peripheral device. For example, if the peripheral device is a camera, the collected functional data is video data or image data; and if the peripheral device is a microphone, the collected functional data is audio data. The peripheral device can also be an input device such as a keyboard, mouse, stylus, or a game controller for obtaining operation input.

In some embodiments, the screen sharing receiver establishes a connection with at least one peripheral device in advance, which can be connected by wired or wireless means. Taking a camera as an example, the camera can be connected to the screen sharing receiver via USB. When no data collection command is received, the camera is in an off or sleep state. After receiving the data collection command, the screen sharing receiver controls the camera to start capturing.

Operation 63: sending the functional data to the screen sharing initiator, where the screen sharing initiator, based on the functional data, uses the provided virtual drive to emulate a functional device corresponding to the peripheral device.

It can be understood that the implementation of this embodiment is similar to the embodiments described above with reference to FIGS. 1-5, and will not be repeated here.

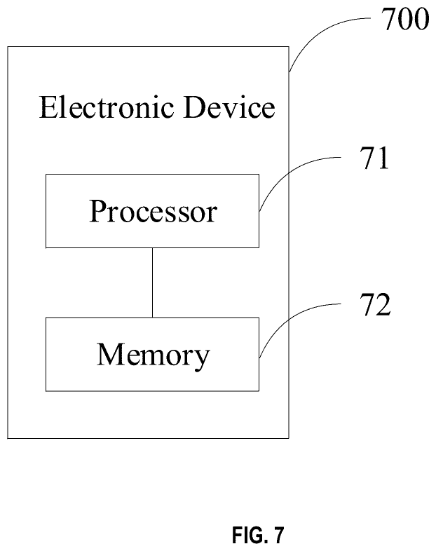

Referring to FIG. 7, FIG. 7 is a structural diagram of an embodiment of an electronic device provided by the present disclosure. The electronic device 700 includes a processor 71 and a memory 72, where the memory 72 is used to store program data.

When the electronic device 700 is a screen sharing initiator, the processor 71 is used to execute the above program data to implement the following method: providing a virtual drive, and sending a data collection command to the screen sharing receiver; receiving functional data sent by the screen sharing receiver, where, in response to the data collection command, the screen sharing receiver controls a peripheral device connected to the screen sharing receiver to perform data collection to obtain the functional data; and based on the functional data, using the virtual drive to emulate a functional device corresponding to the peripheral device.

When the electronic device 700 is a screen sharing receiver, the processor 71 is used to execute the above program data to implement the following method: receiving a data collection command sent by the screen sharing initiator; in response to the data collection command, controlling a peripheral device connected to the screen sharing receiver to perform data collection to obtain functional data; and sending the functional data to the screen sharing initiator, where the screen sharing initiator, based on the functional data, uses the provided virtual drive to emulate a functional device corresponding to the peripheral device.

In this embodiment, the electronic device 700 can be a PC, notebook, television, or can also be a mobile phone, tablet, smart wearable device, etc. For example, it can be a screen casting scenario combining a mobile phone and a television, a conference scenario combining a user terminal (e.g., a computer) and a conference terminal (e.g., a computer), or a scenario combining a computer and a projection device, etc.

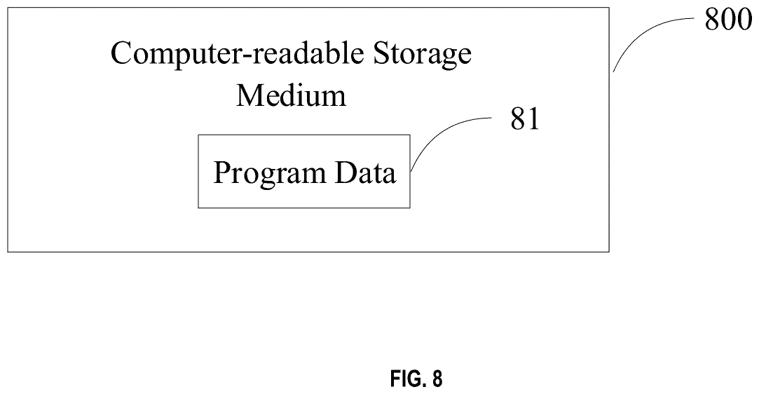

Referring to FIG. 8, FIG. 8 is a structural diagram of an embodiment of a computer-readable storage medium provided by the present disclosure. The computer-readable storage medium 800 stores program data 81, and the program data 81, when executed by a processor, is used to execute the following operations:

Providing a virtual drive, and sending a data collection command to the screen sharing receiver; receiving functional data sent by the screen sharing receiver, where, in response to the data collection command, the screen sharing receiver controls a peripheral device connected to the screen sharing receiver to perform data collection to obtain the functional data; and based on the functional data, using the virtual drive to emulate a functional device corresponding to the peripheral device. Or, receiving a data collection command sent by the screen sharing initiator; in response to the data collection command, controlling a peripheral device connected to the screen sharing receiver to perform data collection to obtain functional data; and sending the functional data to the screen sharing initiator, where the screen sharing initiator, based on the functional data, uses the provided virtual drive to emulate a functional device corresponding to the peripheral device.

The above has provided a detailed description of the device sharing method, electronic device, and computer-readable storage medium provided by the embodiments of the present disclosure. Specific examples are used herein to explain the principles and implementation methods of the present disclosure. The description of the above embodiments is only to help understand the method and core ideas of the present disclosure. At the same time, for those skilled in the art, changes can be made in the specific implementation and application scope according to the ideas of the present disclosure. In summary, the content of this specification should not be construed as a limitation to the present disclosure.

What is claimed is:

1. A device sharing method, performed by a screen sharing initiator, wherein the method comprises:
providing a virtual drive, and sending a data collection command to a screen sharing receiver;
receiving functional data sent by the screen sharing receiver, wherein, in response to the data collection command, the screen sharing receiver controls a peripheral device connected to the screen sharing receiver to perform data collection to obtain the functional data; and
based on the functional data, utilizing the virtual drive to emulate a functional device corresponding to the peripheral device.

2. The method according to claim 1, wherein providing the virtual drive and sending the data collection command to the screen sharing receiver comprises:
in response to a screen sharing application being started, monitoring whether a peripheral sharing function is enabled; and
in response to the peripheral sharing function being enabled, providing the virtual drive, and sending the data collection command to the screen sharing receiver.

3. The method according to claim 2, wherein in response to the screen sharing application being started, monitoring whether the peripheral sharing function is enabled comprises:
in response to the screen sharing application being started, monitoring a state of a peripheral sharing function switch to monitor whether the peripheral sharing function is enabled, wherein the peripheral sharing function switch is configured to enable or disable the peripheral sharing function in response to an input operation.

4. The method according to claim 2, wherein in response to the screen sharing application being started, monitoring whether the peripheral sharing function is enabled comprises:
in response to the screen sharing application being started, displaying an application interface, wherein the application interface comprises a peripheral sharing function button;
in response to a confirmation of the peripheral sharing function button, displaying at least one peripheral type and a switch indicator corresponding to the peripheral type, wherein the switch indicator is configured to enable or disable the peripheral device corresponding to the peripheral type in response to the input operation; and
monitoring the state of the peripheral sharing function switch to monitor whether the peripheral sharing function is enabled.

5. The method according to claim 4, further comprising:
in response to the switch indicator being enabled corresponding to a target peripheral type, displaying a corresponding peripheral device list and a data display interface corresponding to the peripheral device.

6. The method according to claim 2, further comprising:
in response to the peripheral sharing function being disabled, destroying the virtual drive.

7. The method according to claim 2, wherein the screen sharing application integrates a virtual drive, and
wherein in response to the peripheral sharing function being enabled, providing the virtual drive comprises:
in response to the peripheral sharing function being enabled, loading the virtual drive from the screen sharing application.

8. The method according to claim 2, prior to providing a virtual drive, and sending a data collection command to a screen sharing receiver, the method further comprising:
pre-establishing a data transmission channel between the screen sharing initiator and the screen sharing receiver, the data transmission channel being configured to transmit both the data collection command and the functional data.

9. A device sharing method, characterized in that a first electronic device establishes a data transmission channel with a second electronic device, the method comprising:
providing, by the first electronic device, a virtual drive, and sending a data collection command to the second electronic device via the data transmission channel;
in response to the data collection command, controlling, by the second electronic device, a peripheral device connected thereto to perform data collection to obtain functional data, and transmitting the functional data to the first electronic device via the data transmission channel;
emulating, by the first electronic device based on the functional data, a functional device corresponding to the peripheral device using the virtual drive, and acquiring the functional data through the emulated functional device.

10. The method according to claim 9, wherein the first electronic device providing a virtual drive and sending a data collection command to the second electronic device via the data transmission channel comprises:
monitoring, by the first electronic device in response to launching a screen-sharing application, whether a peripheral sharing function is enabled, wherein the screen-sharing application is an application having screen-sharing operation functionality; and
providing the virtual drive and sending the data collection command to the second electronic device via the data transmission channel, in response to the peripheral sharing function being enabled.

11. The method according to claim 10, wherein monitoring whether the peripheral sharing function is enabled in response to launching the screen sharing application comprises:
monitoring, by the first electronic device in response to launching the screen sharing application, a state of a peripheral sharing function switch to determine whether the peripheral sharing function is enabled, wherein the peripheral sharing function switch is configured to enable or disable the peripheral sharing function in response to an input operation.

12. The method according to claim 11, wherein monitoring whether the peripheral sharing function is enabled in response to launching the screen sharing application comprises:
displaying, in response to launching the screen sharing application, a screen sharing application interface comprising a peripheral sharing function button;
displaying, in response to activation of the peripheral sharing function button, at least one peripheral type and a corresponding switch indicator for each peripheral type, wherein each switch indicator is configured to enable or disable a peripheral device corresponding to the respective peripheral type in response to an input operation; and
monitoring a state of the switch indicator to determine whether the peripheral sharing function is enabled.

13. The method according to claim 12, further comprising:
displaying, by the first electronic device in response to the switch indicator being enabled corresponding to a target peripheral type, a corresponding peripheral device list and a data display interface associated with a selected peripheral device.

14. The method according to claim 10, further comprising:
destroying, by the first electronic device, the virtual drive in response to the peripheral sharing function being disabled.

15. The method according to claim 10, wherein:
the screen-sharing application integrates a plurality of virtual drives;
the first electronic device providing a virtual drive and sending a data collection command to the second electronic device via the data transmission channel in response to the peripheral sharing function being enabled comprises:
loading a corresponding virtual drive from the screen-sharing application and sending the data collection command to the second electronic device via the data transmission channel, in response to the peripheral sharing function being enabled.

16. The method according to claim 15, wherein the plurality of virtual drives comprises a virtual camera drive; the method comprising:
loading, by the first electronic device, the virtual camera drive and sending the data collection command to the second electronic device via the data transmission channel;
controlling, by the second electronic device in response to the data collection command, a camera connected thereto to perform data collection to obtain video data or image data, and transmitting the video data or image data to the first electronic device via the data transmission channel; and
emulating, by the first electronic device based on the video data or image data, a virtual camera corresponding to the camera using the virtual camera drive, and acquiring the video data or image data through the virtual camera.

17. The method according to claim 15, wherein the plurality of virtual drives comprises a virtual microphone drive, and the method further comprising:
loading, by the first electronic device, the virtual microphone drive and sending the data collection command to the second electronic device via the data transmission channel;
controlling, by the second electronic device in response to the data collection command, a microphone connected thereto to perform data collection to obtain audio data, and transmitting the audio data to the first electronic device via the data transmission channel; and
emulating, by the first electronic device based on the audio data, a virtual microphone corresponding to the microphone using the virtual microphone drive, and acquiring the audio data through the virtual microphone.

18. A non-transitory computer-readable storage medium storing program data that, when executed by a processor, cause the processor to implement a device sharing method, the method comprising:
providing a virtual drive, and sending a data collection command to a screen sharing receiver;
receiving functional data sent by the screen sharing receiver, wherein, in response to the data collection command, the screen sharing receiver controls a peripheral device connected to the screen sharing receiver to perform data collection to obtain the functional data; and
based on the functional data, utilizing the virtual drive to emulate a functional device corresponding to the peripheral device.

19. The storage medium according to claim 18, wherein providing the virtual drive and sending the data collection command to the screen sharing receiver comprises:
in response to a screen sharing application being started, monitoring whether a peripheral sharing function is enabled; and
in response to the peripheral sharing function being enabled, providing the virtual drive, and sending the data collection command to the screen sharing receiver.

20. The storage medium according to claim 19, wherein in response to the screen sharing application being started, monitoring whether the peripheral sharing function is enabled comprises:
in response to the screen sharing application being started, monitoring a state of the peripheral sharing function switch to monitor whether the peripheral sharing function is enabled, wherein the peripheral sharing function switch is configured to enable or disable the peripheral sharing function in response to an input operation.
